(19) United States
(12) Patent Application Publication
(10) Pub. No.: US 2016/0130394 A1
(43) Pub. Date: May 12, 2016

(54) ISOFLAVONE-BASED POLYMER, LENS AND CAMERA MODULE USING THE SAME

(71) Applicant: SAMSUNG ELECTRO-MECHANICS CO., LTD., Suwon-si (KR)

(72) Inventors: Hoe Chul JUNG, Suwon-si (KR); Jun Young KIM, Suwon-si (KR); In Cheol CHANG, Suwon-si (KR); Ichiro OGURA, Suwon-si (KR); Seung Hyun KANG, Suwon-si (KR)

(73) Assignee: SAMSUNG ELECTRO-MECHANICS CO., LTD., Suwon-si (KR)

(21) Appl. No.: 14/824,487

(22) Filed: Aug. 12, 2015

(30) Foreign Application Priority Data
Nov. 7, 2014 (KR) 10-2014-0154674
Feb. 9, 2015 (KR) 10-2015-0019556

(51) Int. Cl. C08G 65/38; H04N 5/225

(52) U.S. Cl. CPC C08G 65/38; H04N 5/2254

(57) ABSTRACT

An isoflavone-based polymer, a lens containing the isoflavone-based polymer, and a camera module including the lens are provided. The isoflavone-based polymer includes an isoflavone-based skeleton in a main chain thereof, and includes at least one linking group selected from the group consisting of an ester group and a carbonate group. Whereby, the isoflavone-based polymer exhibits excellent optical properties.

### CROSS-REFERENCE TO RELATED APPLICATION

This application claims the priority and benefit of Korean Patent Application Nos. 10-2014-0154674 filed on Nov. 7, 2014 and 10-2015-0019556 filed on Feb. 9, 2015, with the Korean Intellectual Property Office, the disclosures of which are incorporated herein by reference.

### BACKGROUND

The present disclosure relates to an isoflavone-based polymer, a lens and a camera module using the same.

Optical glass or optically transparent resins have been used as raw materials in the manufacturing of optical elements used in the optical systems of various cameras.

There exist various types of optical glass having excellent levels of heat resistance, transparency, dimensional stability, chemical resistance, and the like, and having various refractive indexes (nD) and Abbe numbers (υD), but the use of such optical glass may be problematic, due to factors such as relatively high costs therefor, poor moldability, and low productivity. Particularly, since a significantly high level of technological prowess, as well as relatively high costs are required in order to process optical glass into an aspherical lens used in aberration correction, various limitations on the practical usage of optical glass exist.

Meanwhile, optically transparent resins are used to form the lenses of cameras, and the like.

### RELATED ART DOCUMENT

(Patent Document 1) Japanese Patent Laid-Open Publication No. 2001-106761

(Patent Document 2) Korean Patent Laid-Open Publication No. 10-2005-0076282

### SUMMARY

An aspect of the present disclosure may provide an isoflavone-based polymer exhibiting excellent optical properties.

An aspect of the present disclosure may also provide a lens containing the isoflavone-based polymer.

An aspect of the present disclosure may also provide a camera module including the lens.

According to an aspect of the present disclosure, an isoflavone-based polymer may include an isoflavone-based skeleton in a main chain of the isoflavone-based polymer. The isoflavone-based polymer may include at least one linking group selected from the group consisting of an ester group and a carbonate group.

The isoflavone-based polymer may include a repeating unit represented by Chemical Formula 1 or Chemical Formula 2.

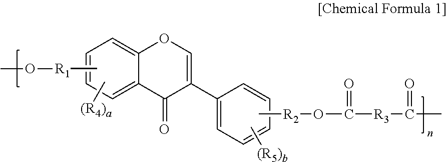

R₁ to R₃ may be the same as or different to each other, and may each independently be a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; R₄ and R₅ may be the same as or different to each other, and may each independently be deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; and a may be an integer of 0 to 3, b may be an integer of 0 to 4, and n may be an integer of 5 to 500.

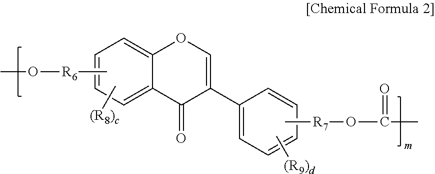

R₆ to R₇ may be the same as or different to each other, and may each independently be a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; R₈ and R₉ may be the same as or different to each other, and may each independently be deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; while c may be an integer of 0 to 3, d may be an integer of 0 to 4, and m may be an integer of 5 to 500.

According to another aspect of the present disclosure, a lens may contain the isoflavone-based polymer as described above, and a camera module may include the lens.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic exploded perspective view illustrating a camera module according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

First, terms used in the present disclosure will be defined.

(1) In the present specification, an aliphatic chain, a straight or branched chain aliphatic compound, may be, for example, a saturated or unsaturated hydrocarbon, alkoxy, alkyl ester, alkyl ether, thioalkyl, or the like, but is not limited thereto. Here, the aliphatic chain may include at least one substituent in a main chain and/or a side chain thereof. In this case, the substituent may be, for example, oxygen, a hydroxyl group, a carboxy group, an alkyl group, a cyano group, an ester group, an ether group, an amide group, an imide group, an alkoxy group, or combinations thereof, but is not limited thereto.

(2) In the present specification, an aliphatic ring, a cyclic aliphatic compound, may be a monocyclic compound or a polycyclic compound formed by the condensation of two or more rings. For example, the aliphatic ring may be a saturated or unsaturated hydrocarbon ring such as cycloalkyl. Meanwhile, in the present specification, the aliphatic ring is used in the sense of including a hetero ring, and thus, a further atom such as a oxygen atom, a phosphorus atom, a silicon atom, or the like, in addition to a carbon atom, may be included in atoms constituting the aliphatic ring. Here, the aliphatic ring may include at least one substituent, and here, the substituent may be, for example, oxygen, a hydroxyl group, a carboxy group, an alkyl group, a cyano group, an ester group, an ether group, an amide group, an imide group, an alkoxy group, or combinations thereof, but is not limited thereto.

(3) In the present specification, an aromatic ring, a cyclic aromatic compound, may be a monocyclic compound or polycyclic compound formed by the condensation of two or more rings. For example, the aromatic ring may be an aryl such as phenyl, naphthalene, or the like. Here, the aromatic ring may include at least one substituent, and here, the substituent may be, for example, an oxygen atom, a hydroxyl group, a carboxy group, an alkyl group, a cyano group, an ester group, an ether group, an amide group, an imide group, an alkoxy group, or combinations thereof, but is not limited thereto.

(4) In the present specification, two or more rings are directly linked to each other, which may mean that the rings are linked to each other by a bond therebetween, such as biphenyl bicyclohexyl, or the like, and two or more rings are cross-linked to each other, which may mean that the rings are linked to each other by a structure such as alkylene, —O—, —C(═O)—, —C(═O)O—, —C(═O) NH—, —O[CH₂CH₂O]ₚ— (here, p is an integer of 1 to 20), or the like.

(5) In the present specification, a glass transition temperature (Tg) refers to a temperature at a point in time when molecules of a polymer material start to move and be active due to an increase in temperature, and may be measured using a differential scanning calorimeter, or the like.

According to an exemplary embodiment in the present disclosure, there is provided an isoflavone-based polymer including an isoflavone-based skeleton in a main chain thereof, including at least one linking group selected from the group consisting of an ester group and a carbonate group.

The isoflavone-based polymer according to the exemplary embodiment in the present disclosure includes the isoflavone-based skeleton therein, such that a refractive index may be improved, and the isoflavone-based polymer includes at least one linking group selected from the group consisting of the ester group and the carbonate group, such that the isoflavone-based polymer may have high degrees of injection-moldability and hardness, thereby exhibiting excellent physical properties at the time of being used in the manufacturing of a lens requiring optical properties and processability.

The isoflavone-based polymer according to the exemplary embodiment in the present disclosure may include at least one repeating unit represented by Chemical Formula 1 and Chemical Formula 2.

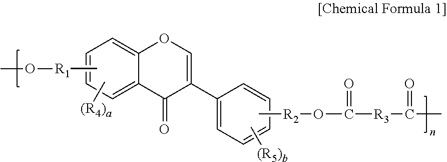

In Chemical Formula 1, R₁ to R₃ may each independently be a substituted or unsubstituted (C₁-C₁₀) aliphatic chain, a substituted or unsubstituted (C₂-C₁₀) aliphatic ring, a substituted or unsubstituted (C₃-C₂₀) aromatic ring, or combinations thereof; R₄ and R₅ may each independently be deuterium, a substituted or unsubstituted (C₁-C₁₀) aliphatic chain, a substituted or unsubstituted (C₂-C₁₀) aliphatic ring, a substituted or unsubstituted (C₃-C₂₀) aromatic ring, or combinations thereof; and a may be an integer of 0 to 3, b may be an integer of 0 to 4, and n may be an integer of 5 to 500. In further detail, n may be an integer of 20 to 200.

On the other hand, in Chemical Formula 1, R₁ and R₂ may each independently be a single bond, OCH₂CH₂, OCH₂CH₂CH₂, CH₂(CH₃)CH, or CH(CH₃)CH₂. In this case, a substituent having a low molecular volume is introduced into an aryl moiety of the isoflavone-based skeleton, such that the refractive index of the isoflavone-based polymer may be increased by increasing a polarity of the isoflavone-based skeleton.

In Chemical Formula 1, R₃ may be a divalent organic group derived from a dicarboxylic acid or a dicarboxylic acid derivative.

Although not particularly limited, the dicarboxylic acid may be an aliphatic dicarboxylic acid, a cycloaliphatic dicarboxylic acid, or an aromatic dicarboxylic acid, and here, the aliphatic dicarboxylic acid may include at least one of alkane dicarboxylic acids and alkene dicarboxylic acids, the cycloaliphatic dicarboxylic acid may include at least one of cycloalkane dicarboxylic acids, dicycloalkane dicarboxylic acids, and tricycloalkane dicarboxylic acids, and the aromatic dicarboxylic acid may include at least one of arene dicarboxylic acids and biphenyl dicarboxylic acids.

For example, the alkane dicarboxylic acid may include at least one of oxalic acid, malonic acid, succinic acid, glutaric acid, and adipic acid, the alkene dicarboxylic acid may include at least one of maleic acid and fumaric acid, the cycloalkane dicarboxylic acid may include cyclohexane dicarboxylic acid, and the dicycloalkane dicarboxylic acid or tricycloalkane dicarboxylic acid may include at least one of decalin dicarboxylic acid, norbornane dicarboxylic acid, and adamantane dicarboxylic acid. In addition, the arene dicarboxylic acid may include at least one of terephthalic acid, isophthalic acid, phthalic acid, 2,6-naphthalene dicarboxylic acid, 1,8-naphthalene dicarboxylic acid, and anthracene dicarboxylic acid, and the biphenyl dicarboxylic acid may include 2,2′-biphenyl dicarboxylic acid.

On the other hand, the dicarboxylic acid derivative may include, for example, at least one of acid anhydrides such as hexahydrophthalic anhydride and tetrahydro phthalic anhydride, (C₁-C₄)alkyl esters such as dimethyl ester and diethylester, and derivatives capable of forming esters of acid halides corresponding to dicarboxylic acids.

R₃ may be changed depending on the kind of monomer actually applied at the time of polymerizing the isoflavone-based derivative.

R₄ and R₅ may each independently be deuterium, a substituted or unsubstituted (C₁-C₄)alkyl, a substituted or unsubstituted (C₆-C₁₀)aryl, a substituted or unsubstituted (C₃-C₁₀)heteroaryl, a substituted or unsubstituted (C₃-C₁₀)cycloalkyl, a substituted or unsubstituted 5 to 7-membered heterocycloalkyl, a substituted or unsubstituted (C₆-C₁₀)ar(C₁-C₄)alkyl, a 5 to 7-membered heterocycloalkyl fused with at least one (C₃-C₁₀)cycloalkyl, or a (C₃-C₁₀)cycloalkyl fused with at least one substituted or unsubstituted aromatic ring.

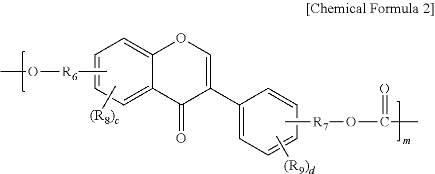

In Chemical Formula 2, R₆ to R₇ may each independently be a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; R₈ and R₉ may each independently be deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; while c may be an integer of 0 to 3, d may be an integer of 0 to 4, and m may be an integer of 5 to 500. In more detail, m may be an integer of 20 to 200.

On the other hand, in Chemical Formula 2, R₆ and R₇ may be the same as or different to each other, and may each independently be a single bond, OCH₂CH₂, OCH₂CH₂CH₂, CH₂(CH₃)CH, or CH(CH₃)CH₂. In this case, a substituent having a low molecular volume is introduced into an aryl moiety of the isoflavone-based skeleton, such that the refractive index of the isoflavone-based polymer may be increased by increasing a polarity of the isoflavone-based skeleton.

In addition, R₈ and R₉ may be the same as or different to each other, and may each independently be deuterium, a substituted or unsubstituted (C₁-C₄)alkyl, a substituted or unsubstituted (C₆-C₁₀)aryl, a substituted or unsubstituted (C₃-C₁₀)heteroaryl, a substituted or unsubstituted (C₃-C₁₀)cycloalkyl, a substituted or unsubstituted 5 to 7-membered heterocycloalkyl, a substituted or unsubstituted (C₆-C₁₀)ar(C₁-C₄)alkyl, a 5 to 7-membered heterocycloalkyl fused with at least one (C₃-C₁₀)cycloalkyl, or a (C₃-C₁₀)cycloalkyl fused with at least one substituted or unsubstituted aromatic ring.

According to the exemplary embodiment in the present disclosure, the isoflavone-based polymer may include the repeating unit represented by Chemical Formula 1 and the repeating unit represented by Chemical Formula 2, such that the isoflavone-based polymer having a high refractive index in a visible light region, excellent optical properties, and high hardness may be provided.

Further, in the isoflavone-based polymer according to the exemplary embodiment in the present disclosure, a halogen substituent such as bromine (Br) or chlorine (Cl), which is used in order to improve optical properties but which causes a dioxine problem, is not introduced to a structural unit thereof, and thus, the isoflavone-based polymer may be eco-friendly.

In addition, the isoflavone-based polymer according to the exemplary embodiment in the present disclosure does not contain sulfur (S), and nitrogen (N) directly linked to at least one hydrogen (H), such that the isoflavone-based polymer of which transparency is secured may be provided.

For example, the isoflavone-based polymer does not contain —NH and —NH₂, such that transparency thereof may be secured.

In addition, the isoflavone-based polymer according to the exemplary embodiment in the present disclosure may have excellent processability and may not be decomposed at a high temperature of 200° C. or more, such that the isoflavone-based polymer may form a lens by injection molding. Further, the isoflavone-based polymer may have a high degree of scratch resistance due to having a high degree of hardness.

On the other hand, the isoflavone-based polymer according to the exemplary embodiment in the present disclosure may be a polymer of an isoflavone-based compound represented by the following [Chemical Formula 3], and here, the polymer may be polymerized by at least one of an esterification reaction and a carbonation reaction.

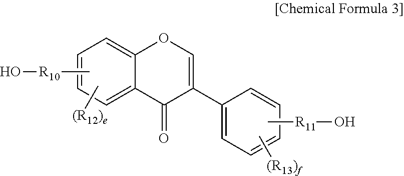

In Chemical Formula 3, R₁₀ and R₁₁ may be the same as or different to each other, and may each independently be a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; R₁₂ and R₁₃ may be the same as or different to each other, and may each independently be deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; and e may be an integer of 0 to 3, and f may be an integer of 0 to 4.

Although not particularly limited, R₁₀ and R₁₁ may be the same as or different to each other, and may each independently be a single bond, OCH₂CH₂, OCH₂CH₂CH₂, CH₂(CH₃)CH, or CH(CH₃)CH₂ in view of increasing the polarity of the isoflavone-based compound to improve the refractive index of the isoflavone-based polymer.

On the other hand, although not particularly limited, R₁₂ and R₁₃ may be the same as or different to each other, and may each independently be deuterium, a substituted or unsubstituted (C₁-C₄)alkyl, a substituted or unsubstituted (C₆-C₁₀)aryl, a substituted or unsubstituted (C₃-C₁₀)heteroaryl, substituted or unsubstituted (C₃-C₁₀)cycloalkyl, a substituted or unsubstituted 5 to 7-membered heterocycloalkyl, a substituted or unsubstituted (C₆-C₁₀)ar(C₁-C₄)alkyl, a 5 to 7-membered heterocycloalkyl fused with at least one (C₃-C₁₀)cycloalkyl, or a (C₃-C₁₀)cycloalkyl fused with at least one substituted or unsubstituted aromatic ring.

On the other hand, although not particularly limited, the esterification reaction may be a reaction of copolymerizing the isoflavone-based compound represented by [Chemical Formula 3] and a dicarboxylic acid or dicarboxylic acid derivative.

Although not particularly limited, the dicarboxylic acid may be an aliphatic dicarboxylic acid, a cycloaliphatic dicarboxylic acid, or an aromatic dicarboxylic acid, and here, the aliphatic dicarboxylic acid may include at least one of alkane dicarboxylic acids and alkene dicarboxylic acids, the cycloaliphatic dicarboxylic acid may include at least one of cycloalkane dicarboxylic acids, dicycloalkane dicarboxylic acids, and tricycloalkane dicarboxylic acids, and the aromatic dicarboxylic acid may include at least one of arene dicarboxylic acids and biphenyl dicarboxylic acids.

For example, the alkane dicarboxylic acid may include at least one of oxalic acid, malonic acid, succinic acid, glutaric acid, and adipic acid, the alkene dicarboxylic acid may include at least one of maleic acid and fumaric acid, the cycloalkane dicarboxylic acid may include cyclohexane dicarboxylic acid, and the dicycloalkane dicarboxylic acid or tricycloalkane dicarboxylic acid may include at least one of decalin dicarboxylic acid, norbornane dicarboxylic acid, and adamantane dicarboxylic acid. In addition, the arene dicarboxylic acid may include at least one of terephthalic acid, isophthalic acid, phthalic acid, 2,6-naphthalene dicarboxylic acid, 1,8-naphthalene dicarboxylic acid, and anthracene dicarboxylic acid, and the biphenyl dicarboxylic acid may include 2,2′-biphenyl dicarboxylic acid.

On the other hand, the dicarboxylic acid derivative may include, for example, at least one of acid anhydrides such as hexahydrophthalic anhydride and tetrahydro phthalic anhydride, (C₁-C₄)alkyl esters such as dimethyl ester and diethylester, and derivatives capable of forming esters of acid halides corresponding to dicarboxylic acids.

Although not particularly limited, the carbonation reaction may be a reaction of copolymerizing the isoflavone-based compound represented by [Chemical Formula 3] and phosgene, diphenyl carbonate, or the like.

According to another exemplary embodiment in the present disclosure, a lens including the isoflavone-based polymer according to the above-mentioned exemplary embodiment in the present disclosure is provided. The isoflavone-based polymer is as described above, and a detailed description thereof will be omitted.

The lens according to the exemplary embodiment in the present disclosure may be formed by molding the isoflavone-based polymer, and may be formed by injection molding.

The lens according to the exemplary embodiment in the present disclosure may be obtained, for example, by injection molding the isoflavone-based polymer in a lens shape using an injection molding machine or injection compression molding machine. Although not particularly limited, an injection molding temperature of the isoflavone-based polymer may be about 200° C. to 300° C. In further detail, the injection molding temperature of the isoflavone-based polymer may be about 240° C. to 280° C.

The lens obtained by molding the isoflavone-based polymer has high refractive properties, and overall optical properties thereof such as transparency, and the like, may be excellent.

For example, a refractive index of the lens according to the exemplary embodiment measured at a wavelength of 587 nm may be 1.60 or more, in detail, 1.640 or more, for example, 1.641 to 1.655, an Abbe number thereof may be 22 or more, for example, about 22 to 25, and transmittance thereof may be 85% or more, for example, about 89% to 93%.

Although not particularly limited, the lens may be formed to be aspherical as needed. Among optical lenses, an aspherical lens is useful as a camera lens. A coating layer such as an anti-reflection layer or a hard coating layer may be formed on a surface of the lens as needed.

The lens may be used in various types of lenses such as pickup lenses, f-θ lenses, eyeglass lenses, and the like. For example, the lens may be used as a lens in a single lens reflex camera, a digital still camera, a video camera, a mobile phone-mounted camera module, a lens-mounted film, a telescope, binoculars, a microscope, a projector, or the like.

In addition, the lens may be applied to a camera module, and according to another exemplary embodiment in the present disclosure, a camera module including the lens may be provided.

Hereinafter, the present disclosure will be described through Embodiment. The following Embodiment is provided to describe exemplary embodiments in the present disclosure, and the scope of the present disclosure is not limited thereto.

### Embodiment

### Synthesis of 3-iodo-7-(tetrahydro-2H-pyran-2-yloxy)-4H-chromen-4-one (Intermediate)

First, as illustrated in the following Reaction Formula 1, an intermediate may be formed using 3,4-dihydro-2H-pyran and 1-(2,4-dihydroxyphenyl)ethanone as a starting material.

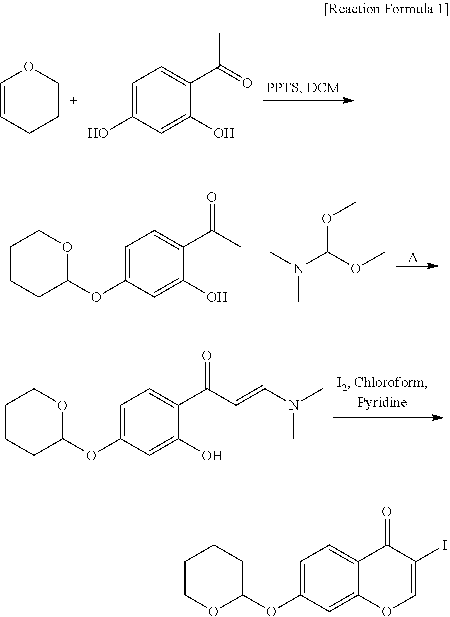

In the present Embodiment, the intermediate was formed using the following method.

After 50 mL of dichloromethane and 9 mL of 3,4-dihydro-2H-pyran were inserted into a 100 mL round bottom flask with a magnetic stirring bar and completely mixed with each other, 5 g of 1-(2,4-dihydroxyphenyl)ethanone) and 300 mg of pyridinium-p-toluenesulfonate were sequentially added thereto and then stirred at room temperature for 4 hours. A reaction end point was confirmed using thin layer chromatography (TLC), and a sodium bicarbonate aqueous solution was added thereto, followed by extraction with dichloromethane.

An obtained organic layer was dried over sodium sulfate, filtered, and then concentrated. The obtained product was diluted with 6.5 mL of N,N-dimethylformamide dimethyl acetal and heated at 95° C. for 3 hours. A reaction endpoint was confirmed using TLC, and the resultant was concentrated under reduced pressure.

The obtained concentrate was diluted with 50 mL of chloroform, and 2.92 mL of pyridine and 16.68 g of solid iodine were added thereto and stirred at room temperature for 12 hours. A reaction end point was confirmed using TLC, and a sodium thiosulfate (Na₂S₂O₃) aqueous solution was added dropwise thereto and stirred at room temperature for 30 minutes, followed by extraction with dichloromethane. The obtained organic layer was dried over sodium sulfate, filtered, and then concentrated.

Next, the remaining concentrate was purified by silica gel column chromatography using hexane/ethyl acetate (5/1 (v/v) to 2/1 (v/v)) as eluent, thereby obtaining 10.78 g of an intermediate as a white solid (yield: 88%). Thereafter, it was confirmed using nuclear magnetic resonance (NMR) that the obtained intermediate was 3-iodo-7-(tetrahydro-2H-pyran-2-yloxy)-4H-chromen-4-one. (¹H NMR (500 MHz, CDCl₃) δ8.28 (s, 1H), 8.17 (d, 1H), 7.16-7.11 (m, 2H), 5.57 (m, 1H), 3.92-3.79 (m, 1H), 3.71-3.63 (m, 1H), 2.10-1.90 (m, 3H), 1.83-1.58 (m, 3H))

### Synthesis of Isoflavone-Based Compounds 1 to 5

Then, after forming the intermediate, a reaction of the intermediate was carried out as illustrated in the following Reaction Formula 2, thereby forming isoflavone-based compounds.

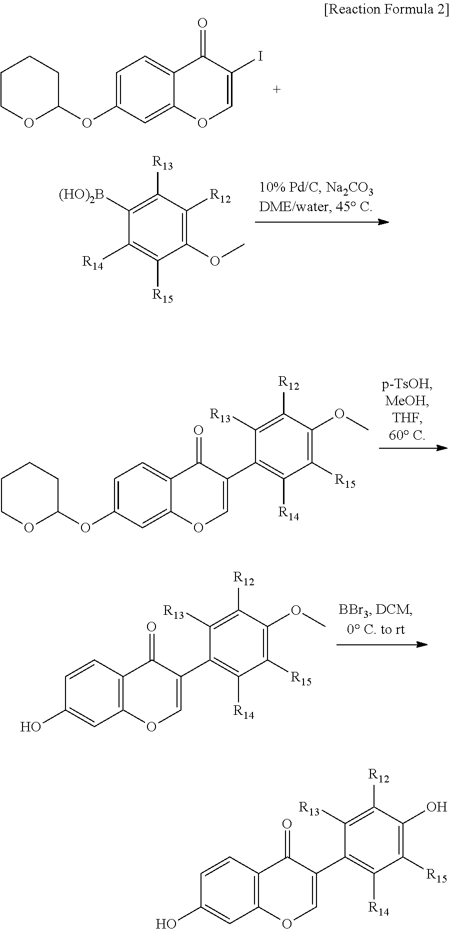

In the present Synthesis Example, isoflavone-based compounds 1 to 5 were formed by the following method.

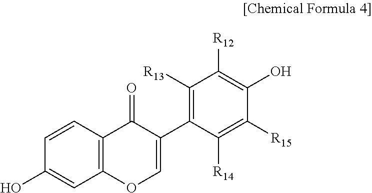

The isoflavone-based compounds 1 to 5 prepared in the present Synthesis Example may be represented by Chemical Formula 4.

The isoflavone-based compound 1 is a compound formed when all of R₁₂ to R₁₅ are hydrogen (H) in Chemical Formula 4, the isoflavone-based compound 2 is a compound when Rig is a methyl group and R₁₃ to R₁₅ are hydrogen (H) in Chemical Formula 4, the isoflavone-based compound 3 is a compound when R₁₃ is a methyl group and R₁₂, R₁₄, and R₁₅ are hydrogen (H) in Chemical Formula 4, the isoflavone-based compound 4 is a compound when R₁₂ and R₁₅ are hydrogen (H) and R₁₃ and R₁₄ are methyl groups in Chemical Formula 4, and the isoflavone-based compound 5 is a compound when R₁₂ and R₁₅ are methyl groups and R₁₃ and R₁₄ are hydrogen (H) in Chemical Formula 4.

First, the isoflavone-based compound 1 was formed as follows.

12 mL of ethylene glycol dimethyl ether and 12 mL of water were inserted into a 100 mL round bottom flask with a magnetic stirring bar, and 1 g of the intermediate formed as described above was dissolved therein. 854 mg of sodium carbonate, 490 mg of 4-methoxyphenylboronic acid, and 142 mg of Pd/C were sequentially added thereto at room temperature. A reaction temperature was maintained at 45° C. for 4 hours, and a reaction end point was confirmed using TLC. A reactor was cooled and maintained at room temperature, and water was added dropwise thereto to dilute the reaction solution, followed by extraction with dichloromethane. An obtained organic layer was dried over sodium sulfate, filtered, and then concentrated. A crude residue obtained by concentrating the reactant was purified by silica gel column chromatography using hexane/ethyl acetate (3/1 (v/v) to 1/1 (v/v)) as eluent. Thereafter, it was confirmed using NMR that the purified product was 4′-methoxy-7-(tetrahydropyran-2-yloxy) isoflavone. (¹H NMR (500 MHz, CDCl₃): δ8.22 (d, 1H), 7.93 (s, 1H), 7.48 (dd, 2H), 7.07 (d, 2H), 6.95 (d, 2H), 5.55 (m, 1H), 3.85 (s, 1H), 3.93-3.81 (m, 1H), 3.74-3.61 (m, 1H), 2.05-1.91 (m, 3H), 1.80-1.59 (m, 3H))

The obtained material was dissolved in 30 mL of methanol and 30 mL of tetrahydrofuran (THF), and 41 mg of p-toluene sulfonic acid was added thereto and stirred at room temperature. A reaction temperature was maintained at 60° C. for 1 hour, 300 μL of triethylamine was added thereto, thereby neutralizing the reaction solution. A crude product obtained by concentrating the reactant was dissolved again in 10 mL of anhydrous dichloromethane. The resultant was cooled to 0° C. while maintaining nitrogen atmosphere, and then, 3 mL of Boron tribromide solution (1.0M in dichloromethane) was added thereto, and heated to room temperature. After a reaction was carried out for 6 hours, a reaction end point was confirmed using TLC. The reaction was terminated by adding ice water, and a pH was adjusted to 6 using 5 wt % of disodium phosphate aqueous solution, followed by extraction with ethyl acetate. An obtained organic layer was dried over sodium sulfate, filtered, and then concentrated. An obtained crude product was dissolved in dichloromethane/methanol, and precipitated in ethyl acetate, thereby obtaining 4′,7-dihydroxyisoflavone (isoflavone-based compound 1, daidzein) as a pale yellow solid (total yield: 39%, purity: 98.1%). Thereafter, a structure of the obtained isoflavone-based compound 1 was confirmed using NMR. (¹H NMR (700 MHz, DMSO): δ10.74 (brs, 1H), 9.50 (brs, 1H), 8.26 (s, 1H), 7.96 (d, 1H), 7.37 (dt, 2H), 6.93 (dd, 1H), 6.84 (d, 1H), 6.80 (dt, 2H))

The same preparation process as that of Synthesis Example of the isoflavone-based compound 1 was performed except for using 4-methoxy-3-methylphenylboronic acid instead of 4-methoxyphenylboronic acid, thereby synthesizing the isoflavone-based compound 2 (total yield: 36%, purity: 97.9%).

The same preparation process as that of Synthesis Example of the isoflavone-based compound 1 was performed except for using 4-methoxy-2-methylphenylboronic acid instead of 4-methoxyphenylboronic acid, thereby synthesizing the isoflavone-based compound 3 (total yield: 31%, purity: 98.4%).

The same preparation process as that of Synthesis Example of the isoflavone-based compound 1 was performed except for using 4-methoxy-2,6-dimethylphenylboronic acid instead of 4-methoxyphenylboronic acid, thereby synthesizing the isoflavone-based compound 4 (total yield: 41%, purity: 97.4%).

The same preparation process as that of Synthesis Example of the isoflavone-based compound 1 was performed except for using 4-methoxy-3,5-dimethylphenylboronic acid instead of 4-methoxyphenylboronic acid, thereby synthesizing the isoflavone-based compound 5 (total yield: 29%, purity: 98.9%).

### Synthesis of Isoflavone-Based Polymer and Evaluation of Properties Thereof

Monomers of isoflavone derivatives having purities of 97% or more, represented by the isoflavone-based compounds 1 to 5 synthesized by the above-mentioned method, were dissolved in a mixed solution of a sodium hydroxide aqueous solution and dichloromethane, respectively, and polymers were obtained by carbonation reactions using phosgene gas. Then, gel permeation chromatography (GPC) molecular weights and glass transition temperatures (Tg) of the polymers were measured, and the results were illustrated in the following Table 1.

TABLE 1

| | GPC Molecular Weight | | | DSC | TGA |
|---|---|---|---|---|---|
| | | Mw, | | Tg | Td 5 wt % |
| Sample | Mn, *1000 | *1000 | Mw/Mn | (° C.) | (° C.) |
| Polymer of | 13.4 | 41.7 | 3.11 | 139 | 398 |
| Isoflavone-Based | | | | | |
| Compound 1 | | | | | |
| Polymer of | 13.6 | 42.4 | 3.12 | 135 | 402 |
| Isoflavone-Based | | | | | |
| Compound 2 | | | | | |
| Polymer of | 13.7 | 42.1 | 3.07 | 135 | 402 |
| Isoflavone-Based | | | | | |
| Compound 3 | | | | | |
| Polymer of | 14.5 | 39.7 | 2.74 | 142 | 407 |
| Isoflavone-Based | | | | | |
| Compound 4 | | | | | |
| Polymer of | 14.1 | 39.5 | 2.80 | 142 | 407 |
| Isoflavone-Based | | | | | |
| Compound 5 | | | | | |

### Formation of Lens and Evaluation of Properties of Lens

The isoflavone-based polymers (hereinafter, referred to isoflavone-based polymers 1 to 5) formed of the isoflavone-based compounds 1 to 5 as Embodiments and a highly refractive resin (EP-5000, by Mitsubishi Gas Chemical) as Comparative Example were inserted into a mold having a length of 2 cm, a width of 2 cm, and a thickness of 1 mm, respectively, and heated to thereby be melted. Then, plate type samples for evaluating optical properties of lenses were manufactured by removing the mold, and refractive indexes, Abbe numbers, and levels of transmittance thereof were measured. The results were illustrated in the following Table 2.

TABLE 2

| | Refractive | | |
|---|---|---|---|
| | Index | Abbe | |
| Sample | (587 nm, 25° C.) | number | Transmittance |
| Isoflavone-based Polymer 1 | 1.651 | 24 | 91% |
| Isoflavone-based Polymer 2 | 1.648 | 25 | 92% |
| Isoflavone-based Polymer 3 | 1.649 | 25 | 92% |
| Isoflavone-based Polymer 4 | 1.651 | 24 | 93% |
| Isoflavone-based Polymer 5 | 1.652 | 24 | 93% |
| Comparative Example | 1.635 | 24 | 85% |
| (Mitsubishi Gas Chemical) | | | |

Referring to Table 1, it may be appreciated that the isoflavone-based polymers according to the exemplary embodiment in the present disclosure had low glass transition temperatures (Tg) for enhanced injection moldability, and referring to Table 2, it may be appreciated that the lenses formed of the isoflavone-based polymer according to the exemplary embodiment in the present disclosure had refractive indexes of 1.640 or more, in detail, high refractive indexes of 1.65 or so, and high levels of transmittance of 90% or more.

### Camera Module

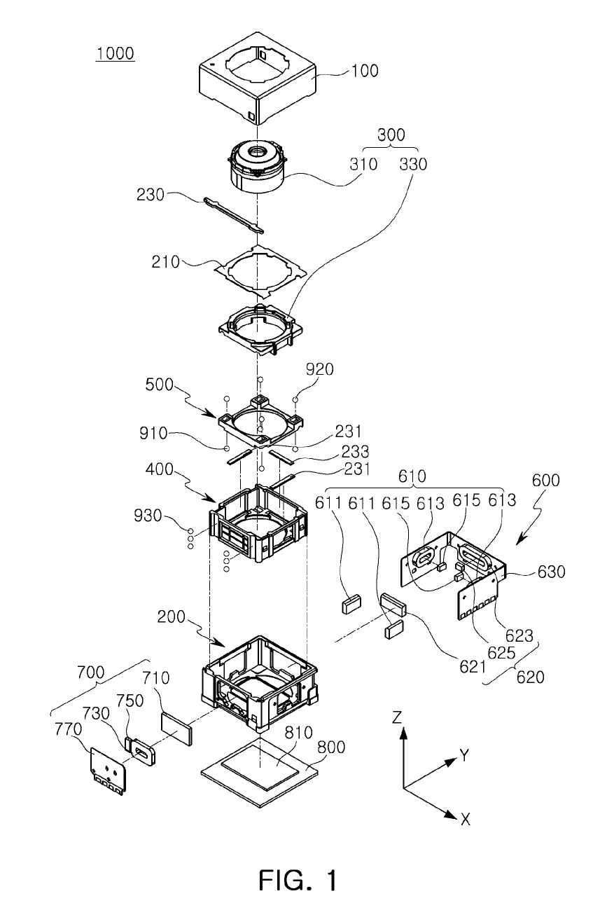

Hereinafter, a camera module according to an exemplary embodiment in the present disclosure will be described with reference to the accompanying drawing. FIG. 1 is a schematic exploded perspective view illustrating a camera module according to an exemplary embodiment in the present disclosure.

Referring to FIG. 1, a camera module 1000 according to an exemplary embodiment in the present disclosure may include a housing 200, a first frame 400 accommodated in the housing 200, a second frame 500 and a lens module 300 accommodated in the first frame 400, and lens driving devices 600 and 700 and a case 100 coupled to the housing 200.

The lens module 300 may include a lens barrel 310 and a third frame 330 in which the lens barrel 310 is accommodated.

The lens barrel 310 may have a hollow cylindrical shape so that a plurality of lenses for imaging an object may be accommodated therein, and the plurality of lenses may be provided in the lens barrel 310 to be arranged on an optical axis.

The numbers of lenses in the lens barrel 310 may be varied depending on a design of the lens barrel 310, and the respective lenses may have optical characteristics such as the same refractive index, different refractive indices, or the like.

The lens barrel 310 may be coupled to the third frame 330.

The third frame 330 may be accommodated in the first frame 400 together with the second frame 500. For example, the second frame 500 and the third frame 330 may be sequentially disposed in the interior of the first frame 400.

In addition, the second frame 500 and the third frame 330 may be disposed to be spaced apart from an internal bottom surface of the first frame 400 in an optical axis direction (a Z-axis direction).

For example, the internal bottom surface of the first frame 400 and a bottom surface of the second frame 500 may be disposed to be spaced apart from each other in the optical axis direction (the Z-axis direction), and a top surface of the second frame 500 and a bottom surface of the third frame 330 may be disposed to be spaced apart from each other in the optical axis direction (the Z-axis direction).

The first frame 400, the second frame 500, and the third frame 330 may be accommodated in the housing 200.

In addition, a first substrate 800 on which an image sensor 810 is mounted may be coupled to the bottom of the housing 200.

The housing 200 may be formed to be open in the optical axis direction (the Z-axis direction) so that external light such as light from outside of the camera module 1000 is incident on the image sensor 810.

On the other hand, for auto-focusing, the first frame 400, the second frame 500, and the third frame 330 may be movable in the housing 200 in the optical axis direction (the Z-axis direction).

In this case, a stopper 210 may be mounted on the housing 200 so as to restrict moving distances of the first frame 400, the second frame 500, and the third frame 330.

The stopper 210 may serve to prevent the third frame 330 from being separated from the housing 200 by external impacts, or the like.

The case 100 may be coupled to the housing 200 to enclose outer surfaces of the housing 200 and serve as an electromagnetic shield for blocking electromagnetic waves, generated during driving of the camera module.

The first frame 400, the second frame 500, and the third frame 330 may be disposed to be movable, relative to the housing 200.

In addition, the third frame 330 and the second frame 500 may be disposed in the first frame 400 to be movable, relative to the first frame 400.

The camera module 1000 according to the exemplary embodiment in the present disclosure may include the lens driving devices 600 and 700.

The lens driving devices 600 and 700 may include a hand shake compensation part 600 and an auto-focus driving part 700.

The hand shake compensation part 600 may be used in order to correct image blurring or moving image shaking, due to a factor such as hand shake, at the time of capturing still or moving images.

For example, when hand shake is generated at the time of capturing images, the hand shake compensation part 600 may compensate for hand shake by allowing the third frame 330 to be relatively displaced to offset the effects of the hand shake.

The auto-focus driving part 700 may be used for an auto-focusing or zoom function.

The auto-focus or zoom function may be performed by allowing the third frame 330 to be movable in the optical axis direction (the Z-axis direction) by the auto-focus driving part 700.

For example, the auto-focus driving part 700 may include a third magnet 710, a third coil 730, and a third substrate 770, and here, the third magnet 710 may be provided on one surface of the first frame 400, the third coil 730 may be disposed to face the third magnet 710, and the third substrate 770 may apply power to the third coil 730. In addition, the auto-focus driving part 700 may further include a third hall sensor 750 configured to sense a position of the third magnet 710.

The third coil 730 may be mounted on the third substrate 770 to thereby be disposed to face the third magnet 710, and the third substrate 770 may be fixed to one surface of the housing 200.

The auto-focus driving part 700 may move the first frame 400 in the optical axis direction (the Z-axis direction) by electromagnetic interaction between the third magnet 710 and the third coil 730.

As set forth above, according to exemplary embodiments in the present disclosure, the isoflavone-based polymer having a high refractive index, excellent optical properties, and high hardness may be provided.

In addition, the isoflavone-based polymer according to the exemplary embodiment in the present disclosure may be eco-friendly, and have improved transparency.

Further, the isoflavone-based polymer according to the exemplary embodiment in the present disclosure may have excellent processability to thereby form a lens by injection molding, and have a high degree of scratch resistance due to having a high degree of hardness.

According to another exemplary embodiment in the present disclosure, the lens of which optical properties and transparency are improved due to the isoflavone-based polymer contained therein, and the camera module to which the lens is applied may be provided.

While exemplary embodiments have been shown and described above, it will be apparent to those skilled in the art that modifications and variations could be made without departing from the scope of the present invention as defined by the appended claims.

What is claimed is:

1. An isoflavone-based polymer comprising an isoflavone-based skeleton in a main chain of the isoflavone-based polymer,
wherein the isoflavone-based polymer includes at least one linking group selected from the group consisting of an ester group and a carbonate group.

2. The isoflavone-based polymer of claim 1, wherein the isoflavone-based polymer includes a repeating unit represented by Chemical Formula 1: 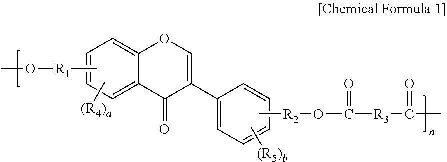
in Chemical Formula 1, R₁ to R₃ are the same as or different to each other, and are each independently a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof;
R₄ and R₅ are the same as or different to each other, and are each independently deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; and
a is an integer of 0 to 3, b is an integer of 0 to 4, and n is an integer of 5 to 500.

3. The isoflavone-based polymer of claim 2, wherein R₁ and R₂ are the same as or different to each other, and are each independently a single bond, OCH₂CH₂, OCH₂CH₂CH₂, CH₂(CH₃)CH, or CH(CH₃)CH₂.

4. The isoflavone-based polymer of claim 2, wherein R₃ is a divalent organic group derived from a dicarboxylic acid or a dicarboxylic acid derivative.

5. The isoflavone-based polymer of claim 2, wherein R₄ and R₅ are the same as or different to each other, and are each independently deuterium, a substituted or unsubstituted (C₁-C₄)alkyl, a substituted or unsubstituted (C₆-C₁₀)aryl, a substituted or unsubstituted (C₃-C₁₀)heteroaryl, a substituted or unsubstituted (C₃-C₁₀)cycloalkyl, a substituted or unsubstituted 5 to 7-membered heterocycloalkyl, a substituted or unsubstituted (C₆-C₁₀)ar(C₁-C₄)alkyl, a 5 to 7-membered heterocycloalkyl fused with at least one (C₃-C₁₀)cycloalkyl, or a (C₃-C₁₀)cycloalkyl fused with at least one substituted or unsubstituted aromatic ring.

6. The isoflavone-based polymer of claim 1, wherein the isoflavone-based polymer includes a repeating unit represented by the following [Chemical Formula 2]: 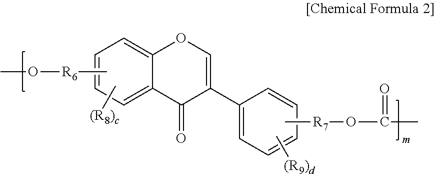
in Chemical Formula 2, R₆ and R₇ are the same as or different to each other, and are each independently a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof;
R₈ and R₉ are the same as or different to each other, and are each independently deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; and
c is an integer of 0 to 3, d is an integer of 0 to 4, and m is an integer of 5 to 500.

7. The isoflavone-based polymer of claim 6, wherein R₆ and R₇ are the same as or different to each other, and are each independently a single bond, OCH₂CH₂, OCH₂CH₂CH₂, CH₂ (CH₃)CH, or CH(CH₃) CH₂.

8. The isoflavone-based polymer of claim 6, wherein R₈ and R₉ are the same as or different to each other, and are each independently deuterium, a substituted or unsubstituted (C₁-C₄)alkyl, a substituted or unsubstituted (C₆-C₁₀)aryl, a substituted or unsubstituted (C₃-C₁₀)heteroaryl, a substituted or unsubstituted (C₃-C₁₀)cycloalkyl, a substituted or unsubstituted 5 to 7-membered heterocycloalkyl, a substituted or unsubstituted (C₆-C₁₀)ar(C₁-C₄)alkyl, a 5 to 7-membered heterocycloalkyl fused with at least one (C₃-C₁₀)cycloalkyl, or a (C₃-C₁₀)cycloalkyl fused with at least one substituted or unsubstituted aromatic ring.

9. The isoflavone-based polymer of claim 1, wherein the isoflavone-based polymer does not contain a halogen substituent.

10. The isoflavone-based polymer of claim 1, wherein the isoflavone-based polymer does not contain a sulfur (S) atom.

11. The isoflavone-based polymer of claim 1, wherein the isoflavone-based polymer does not contain nitrogen (N) directly linked to at least one hydrogen (H).

12. An isoflavone-based polymer being a polymer of an isoflavone-based compound represented by the following [Chemical Formula 3], wherein the polymer is polymerized by at least one of an esterification reaction and a carbonation reaction: 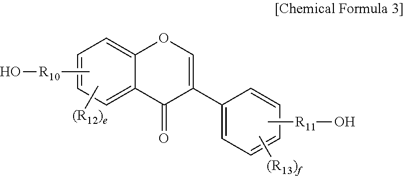
in Chemical Formula 3,
R₁₀ and R₁₁ are the same as or different to each other, and are each independently a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof;
R₁₂ and R₁₃ are the same as or different to each other, and are each independently deuterium, a substituted or unsubstituted (C₁-C₁₀) aliphatic chain, a substituted or unsubstituted (C₃-C₁₀) aliphatic ring, a substituted or unsubstituted (C₃-C₂₀) aromatic ring, or combinations thereof; and
e is an integer of 0 to 3, and f is an integer of 0 to 4.

13. The isoflavone-based polymer of claim 12, wherein R₁₀ and R₁₁ are the same as or different to each other, and are each independently a single bond, OCH₂CH₂, OCH₂CH₂CH₂, CH₂(CH₃)CH, or CH(CH₃)CH₂.

14. The isoflavone-based polymer of claim 12, wherein R₁₂ and R₁₃ are the same as or different to each other, and are each independently deuterium, a substituted or unsubstituted (C₁-C₄)alkyl, a substituted or unsubstituted (C₆-C₁₀)aryl, a substituted or unsubstituted (C₃-C₁₀)heteroaryl, a substituted or unsubstituted (C₃-C₁₀)cycloalkyl, a substituted or unsubstituted 5 to 7-membered heterocycloalkyl, a substituted or unsubstituted (C₆-C₁₀)ar(C₁-C₄)alkyl, a 5 to 7-membered heterocycloalkyl fused with at least one (C₃-C₁₀)cycloalkyl, or a (C₃-C₁₀)cycloalkyl fused with at least one substituted or unsubstituted aromatic ring.

15. A lens comprising the isoflavone-based polymer of claim 1.

16. The lens of claim 15, wherein the lens is formed by injection molding the isoflavone-based polymer.

17. The lens of claim 15, wherein a refractive index of the lens measured at a wavelength of 587 nm is 1.60 or more.

18. A camera module comprising a lens containing the isoflavone-based polymer of claim 1.
